(19) United States
(12) Patent Application Publication
(10) Pub. No.: US 2025/0261257 A1
(43) Pub. Date: Aug. 14, 2025

(54) TERMINAL AGGERATION ESTABLISHMENT METHOD AND APPARATUS, TERMINAL AGGERATION ESTABLISHMENT CONFIGURATION METHOD AND APPARATUS, AND COMMUNICATION DEVICE

(71) Applicant: VIVO MOBILE COMMUNICATION CO., LTD., Guangdong (CN)

(72) Inventors: Boubacar KIMBA DIT ADAMOU, Guangdong (CN); Xiaodong YANG, Guangdong (CN); Jiamin LIU, Guangdong (CN); Qian ZHENG, Guangdong (CN)

(21) Appl. No.: 19/194,639

(22) Filed: Apr. 30, 2025

Related U.S. Application Data
(63) Continuation of application No. PCT/CN2023/126695, filed on Oct. 26, 2023.

(30) Foreign Application Priority Data
Nov. 3, 2022 (CN) 202211372013.2

(51) Int. Cl. H04W 76/14; H04W 76/27; H04W 88/04

(52) U.S. Cl. CPC H04W 76/14; H04W 76/27; H04W 88/04

(57) ABSTRACT

The application discloses a terminal aggregation establishment method and apparatus, a terminal aggregation establishment configuration method and apparatus, and a communication device. The method includes: sending, by a first terminal, information about a second terminal to a network-side device, where the information about the second terminal is used to assist the network-side device in configuring configuration information for establishing multi-terminal aggregation; receiving, by the first terminal, the configuration information sent by the network-side device; and establishing, by the second terminal, multi-path transmission for multi-terminal aggregation with the first terminal based on the configuration information.

### CROSS-REFERENCE TO RELATED APPLICATIONS

This application is a continuation application of International Application No. PCT/CN2023/126695, filed on Oct. 26, 2023. International Application No. PCT/CN2023/126695 claims priority to Chinese Patent Application No. 202211372013.2, filed in China on Nov. 3, 2022. Each of the above-listed applications is incorporated herein by reference in its entirety.

### TECHNICAL FIELD

This application pertains to the field of communications technologies, and specifically relates to a terminal aggregation establishment method and apparatus, a terminal aggregation establishment configuration method and apparatus, and a communication device.

### BACKGROUND

In wireless communication systems, the relay technology involves addition of one or more relay nodes between a base station and a terminal. These nodes are responsible for forwarding radio signals one or more times, meaning that the radio signals need to go through multiple hops before reaching the terminal.

The radio relay technology can be used to expand cell coverage and make up for blind spots in cell coverage, and also improve the cell capacity through spatial resource multiplexing. For indoor coverage, the relay technology can also play a role in overcoming penetration loss and improving indoor coverage quality. Using a two-hop relay as an example, a radio relay divides one link from the base station to the terminal into two links, one from the base station to a relay station and the other from the relay station to the terminal, so as to replace one link with poor quality by using two links with better quality to achieve higher link capacity and better coverage.

Currently, a relay supported in long term evolution (LTE) is a UE-to-Network relay, that is, one end of the relay is connected to the terminal (User Equipment, UE) and the other is connected to a network side. The UE connected to the relay is referred to as remote UE.

How to support a UE-to-network relay mechanism is also a focus of study in new radio (NR). A typical scenario is shown in FIG. 1. The figure shows a representative UE-to-Network scenario where remote UE needs to transmit data to the network side but, due to inadequate coverage, finds relay UE to act as an intermediary. Here, an interface between the relay UE and the base station is a Uu interface, and an interface between the relay UE and the remote UE is a sidelink PC5 interface. Generally, the relay UE is open and can serve any remote UE.

The sidelink relay architecture is a case of a multi-path scenario, and how to establish multi-path transmission for multi-terminal aggregation in the multi-path scenario is an issue to be urgently addressed.

### SUMMARY

According to a first aspect, a multi-terminal aggregation establishment method is provided, including:
sending, by a first terminal, information about a second terminal to a network-side device, where the information about the second terminal is used to assist the network-side device in configuring configuration information for establishing multi-terminal aggregation;
receiving, by the first terminal, the configuration information sent by the network-side device; and
establishing, by the first terminal, multi-path transmission for multi-terminal aggregation with the second terminal based on the configuration information.

According to a second aspect, a multi-terminal aggregation establishment method is provided, including:
sending, by a second terminal, information about the second terminal to a first terminal, where the information about the second terminal is used to assist a network-side device in configuring configuration information for establishing multi-terminal aggregation;
receiving, by the second terminal, the configuration information sent by the network-side device; and
establishing, by the second terminal, multi-path transmission for multi-terminal aggregation with the first terminal based on the configuration information.

According to a third aspect, a multi-terminal aggregation establishment configuration method is provided, including:
receiving, by a network-side device, information about a second terminal sent by a first terminal; where the second terminal is a target terminal selected by the first terminal;
configuring, by the network-side device based on the information about the second terminal, configuration information for establishing multi-terminal aggregation; and
sending, by the network-side device, the configuration information to the first terminal and/or the second terminal.

According to a fourth aspect, a multi-terminal aggregation establishment apparatus is provided, including:
a first sending module, configured to send information about a second terminal to a network-side device, where the information about the second terminal is used to assist the network-side device in configuring configuration information for establishing multi-terminal aggregation;
a first receiving module, configured to receive the configuration information sent by the network-side device; and
a first establishment module, configured to establish multi-path transmission for multi-terminal aggregation with the second terminal based on the configuration information.

According to a fifth aspect, a multi-terminal aggregation establishment apparatus is provided, including:
a third sending module, configured to send information about a second terminal to a first terminal, where the information about the second terminal is used to assist a network-side device in configuring configuration information for establishing multi-terminal aggregation;
a fourth receiving module, configured to receive the configuration information sent by the network-side device; and
a second establishment module, configured to establish multi-path transmission for multi-terminal aggregation with the first terminal based on the configuration information.

According to a sixth aspect, a multi-terminal aggregation establishment configuration apparatus is provided, including:
a sixth receiving module, configured to receive information about a second terminal sent by a first terminal; where the second terminal is a target terminal selected by the first terminal;
a configuration module, configured to, based on the information about the second terminal, configure configuration information for establishing multi-terminal aggregation; and
a fifth sending module, configured to send the configuration information to the first terminal and/or the second terminal.

According to a seventh aspect, a communication device is provided, where the communication device includes a processor, a memory, and a program or instructions stored in the memory and capable of running on the processor, and when the program or the instructions are executed by the processor, the steps of the method according to the first aspect, the second aspect, or the third aspect are implemented.

According to an eighth aspect, a readable storage medium is provided, where a program or instructions are stored in the readable storage medium, and when the program or the instructions are executed by a processor, the steps of the method according to the first aspect, the second aspect, or the third aspect are implemented.

According to a ninth aspect, a chip is provided, where the chip includes a processor and a communication interface, the communication interface is coupled to the processor, and the processor is configured to run a program or instructions to implement the steps of the method according to the first aspect, the second aspect, or the third aspect.

According to a tenth aspect, a computer program/program product is provided, where the computer program/program product is stored in a non-transitory storage medium, and the program/program product is executed by at least one processor to implement the steps of the method according to the first aspect, the second aspect, or the third aspect.

According to an eleventh aspect, a communication system is provided, where the communication system includes a terminal and a network-side device, the terminal is configured to execute the steps of the method according to the first aspect or the second aspect; and the network-side device is configured to execute the steps of the method according to the third aspect.

### BRIEF DESCRIPTION OF DRAWINGS

FIG. 1 is a schematic diagram of a UE-to-network relay scenario;

FIG. 2 is a schematic diagram of an RRC connection establishment process for remote UE;

FIG. 3 is a schematic architectural diagram of a wireless communication system according to an embodiment of this application;

FIG. 4 is a first schematic diagram of a multi-UE aggregation establishment method according to an embodiment of this application;

FIG. 5 is a second schematic diagram of a terminal aggregation establishment method according to an embodiment of this application;

FIG. 6 is a third schematic diagram of a terminal aggregation establishment method according to an embodiment of this application;

FIG. 7 is a fourth schematic diagram of a terminal aggregation establishment method according to an embodiment of this application;

FIG. 8 is a fifth schematic diagram of a terminal aggregation establishment

method according to an embodiment of this application;

FIGS. 9a, 9b, and 9c are schematic diagrams of a multi-path scenario based on an SL relay architecture;

FIGS. 10a, 10b, and 10c are schematic diagrams of a multi-path scenario based on an ideal inter-UE connection architecture;

FIG. 11 is a first schematic diagram of a terminal aggregation establishment apparatus according to an embodiment of this application;

FIG. 12 is a second schematic diagram of a terminal aggregation establishment apparatus according to an embodiment of this application;

FIG. 13 is a third schematic diagram of the terminal aggregation establishment apparatus according to an embodiment of this application;

FIG. 14 is a schematic diagram of a terminal according to an embodiment of this application;

FIG. 15 is a schematic diagram of a network-side device according to an embodiment of this application; and

FIG. 16 is a schematic diagram of a communication device according to an embodiment of this application.

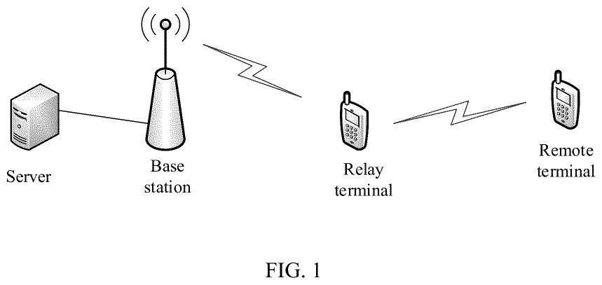

### DETAILED DESCRIPTION OF EMBODIMENTS

The following clearly describes the technical solutions in the embodiments of this application with reference to the accompanying drawings in the embodiments of this application. Apparently, the described embodiments are only some rather than all of the embodiments of this application. All other embodiments obtained by persons of ordinary skill in the art based on the embodiments of this application shall fall within the protection scope of this application.

The terms “first”, “second”, and the like in this specification and claims of this application are used to distinguish between similar objects rather than to describe a specific order or sequence. It should be understood that terms used in this way are interchangeable in appropriate circumstances so that the embodiments of this application can be implemented in other orders than the order illustrated or described herein. In addition, “first” and “second” are usually used to distinguish objects of a same type, and do not restrict a quantity of objects. For example, there may be one or a plurality of first objects. In addition, “and/or” in the specification and claims represents at least one of connected objects, and the character “/” generally indicates that the associated objects have an “or” relationship.

It should be noted that technologies described in the embodiments of this application are not limited to a long term evolution (LTE) or LTE-Advanced (LTE-A) system, and may also be applied to other wireless communication systems, for example, code division multiple access (CDMA), time division multiple access (TDMA), frequency division multiple access (FDMA), orthogonal frequency division multiple access (OFDMA), single-carrier frequency-division multiple access (SC-FDMA), and other systems. The terms “system” and “network” in the embodiments of this application are often used interchangeably, and the technology described herein may be used in the above-mentioned systems and radio technologies as well as other systems and radio technologies. In the following descriptions, a new radio (NR) system is described for an illustration purpose, and NR terms are used in most of the following descriptions, although these technologies may also be applied to other applications than an NR system application, for example, the 6^{th} generation (6^{th} Generation, 6G) communication system.

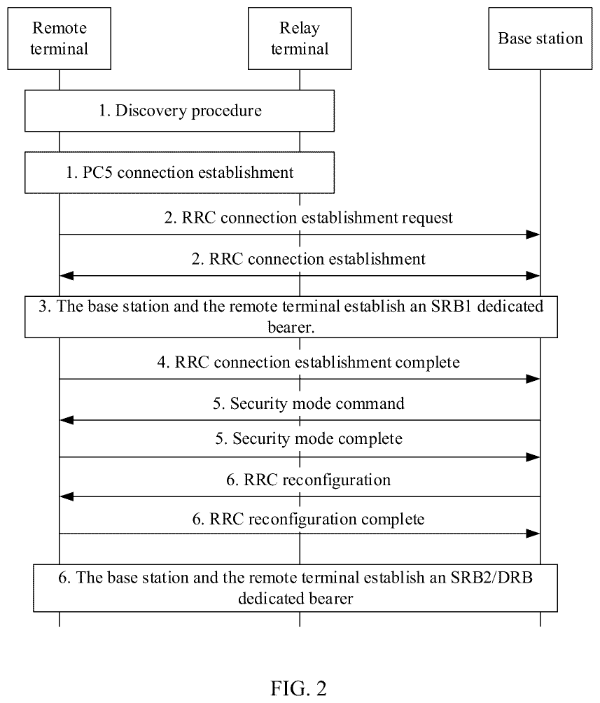

To facilitate understanding on the embodiments of this application, the following describes a radio resource control (RRC) connection establishment process in a sidelink relay scenario with reference to FIG. 2.

Step 1: Remote UE and relay UE perform a discovery procedure, and then establish a PC5 RRC connection.

Step 2: The remote UE sends an RRC setup request to a base station, and the base station returns an RRC setup message to the remote UE. Specifically, these two messages are forwarded to the base station or the remote UE through the relay UE

Step 3: A signaling radio bearer (SRB) 1 dedicated bearer is established between the base station and the remote UE, where the SRB1 of the remote UE is formed by two radio link control (RLC) channels, namely PC5 (between the remote UE and the relay UE) and Uu (between the relay UE and the base station). Specifically, two RLC channels are used for the remote UE to send or receive RRC messages of SRB1 type to or from the base station.

Step 4: The remote UE sends an RRC setup complete message to the base station. Specifically, this message is forwarded to the base station through the relay UE.

Step 5: Security between the remote UE and the base station is activated. The security activation messages and procedure use the mechanism in related technologies.

Step 6: A dedicated SRB2/data radio bearer (DRB) bearer is established between the base station and the remote UE, where the SRB2 or DRB dedicated bearer of the remote UE is formed by two RLC channels, namely PC5 (between the remote UE and the relay UE) and Uu (between the relay UE and the base station). Specifically, two RLC channels are used for the remote UE to send or receive, to or from the base station, RRC/non-access stratum (NAS) messages of SRB2 type as well as uplink and downlink service data. Specifically, the RRC reconfiguration mechanism in related technologies is used.

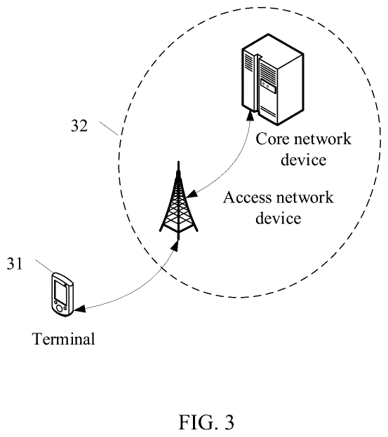

FIG. 3 illustrates a block diagram of a wireless communication system to which an embodiment of this application can be applied. The wireless communication system includes a terminal 31 and a network-side device 32.

The terminal 31 may be a terminal-side device such as a mobile phone, a tablet computer (Tablet Personal Computer), a laptop computer, a personal digital assistant (PDA), a palmtop computer, a netbook, an ultra-mobile personal computer (UMPC), a mobile Internet device (MID), an augmented reality (AR)/virtual reality (VR) device, a robot, a wearable device, vehicle user equipment (VUE), pedestrian user equipment (PUE), a smart home device (a home device with wireless communication function, such as a refrigerator, a television, a washing machine, or a furniture), a game console, a personal computer (PC), a teller machine, a self-service machine, or the like. The wearable device includes: a smart watch, a wrist band, smart earphones, smart glasses, smart jewelry (smart bracelet, smart wristband, smart ring, smart necklace, smart anklet, smart ankle bracelet, or the like), smart wristband, smart clothing, and the like. In addition to the terminal device, the terminal involved in this application may alternatively be a chip in the terminal, such as a modem chip or a system on chip (SoC). It should be noted that a specific type of the terminal 31 is not limited in the embodiments of this application.

The network-side device 32 may include an access network device or a core network device, where the access network device may also be referred to as a radio access network device, a radio access network (Radio Access Network, RAN), a radio access network function, or a radio access network unit. The access network device may include a base station, a wireless local area network (WLAN) access point, a wireless fidelity (Wi-Fi) node, or the like. The base station may be referred to as a NodeB, an evolved NodeB (evolved Node B, eNB), an access point, a base transceiver station (BTS), a radio base station, a radio transceiver, a basic service set (BSS), an extended service set (ESS), a home NodeB, a home evolved NodeB, a transmission and reception point (Transmission Reception Point, TRP), or another appropriate term in the art. Provided that a same technical effect is achieved, the base station is not limited to a specific technical term. It should be noted that in the embodiments of this application, the base station in the NR system is merely used as an example, and a specific type of the base station is not limited.

The core network device may include but is not limited to at least one of the following: a core network node, a core network function, a mobility management entity (MME), an access and mobility management function (AMF), a session management function (SMF), a user plane function (UPF), a policy control function (PCF), a policy and charging rules function (PCRF), an edge application server discovery function (EASDF), a unified data management (UDM), a unified data repository (UDR), a home subscriber server (HSS), a centralized network configuration (CNC), a network repository function (NRF), a network exposure function (NEF), a local NEF (or L-NEF), a binding support function (BSF), an application function (AF), and the like. It should be noted that, in the embodiments of this application, a core network device in an NR system is used as an example for description, and a specific type of the core network device is not limited.

The following describes in detail a terminal aggregation establishment method and apparatus, a terminal aggregation establishment configuration method and apparatus, and a communication device provided in the embodiments of this application by using some embodiments and application scenarios thereof with reference to the accompanying drawings.

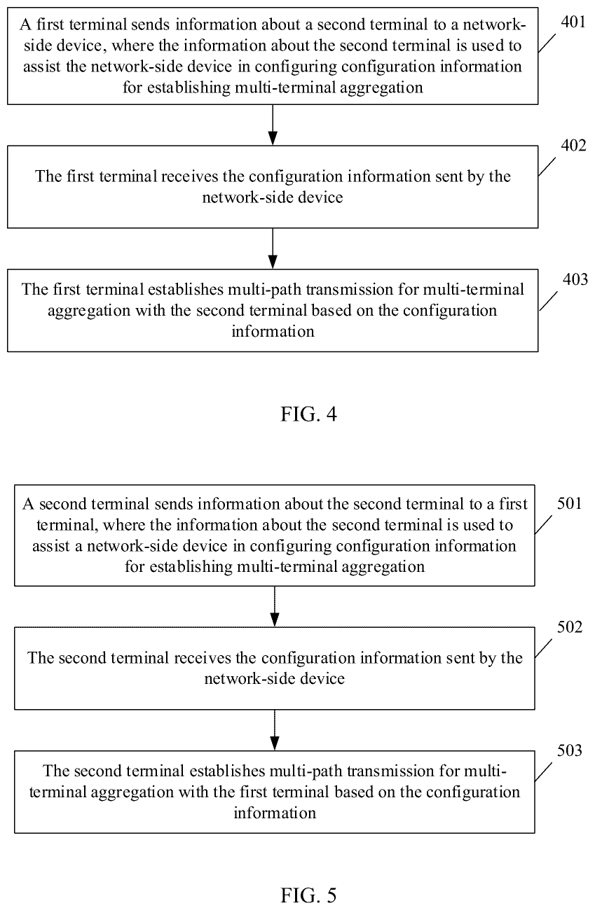

Referring to FIG. 4, an embodiment of the application provides a multi-terminal aggregation establishment method, applied to a first terminal, including but not limited to a relay terminal and secondary UE, and specific steps include step 401, step 402, and step 403.

Step 401: The first terminal sends information about a second terminal to a network-side device, where the information about the second terminal is used to assist the network-side device in configuring configuration information for establishing multi-terminal aggregation.

The configuration information is used for establishing multi-terminal aggregation between the first terminal and the second terminal.

In an implementation of this application, the information about the second terminal includes at least one of the following:
(1) an identifier of the second terminal;
for example, a cell radio network temporary identifier (Cell RNTI, C-RNTI);
(2) serving cell information of the second terminal;
for example, a new radio interface cell global identifier (NR Cell Global Identifier, NCGI);
(3) public land mobile network (PLMN) information about the second terminal;
(4) link quality between the first terminal and the second terminal; and
(5) Uu link quality of the second terminal.

Step 402: The first terminal receives the configuration information sent by the network-side device.

Step 403: The first terminal establishes multi-path transmission for multi-terminal aggregation with the second terminal based on the configuration information.

That is, the first terminal can complete the process of multi-terminal aggregation establishment based on the configuration information.

In an implementation of this application, the method further includes: sending, by the first terminal, a first message to the second terminal; and receiving, by the first terminal, the information about the second terminal.

The first message satisfies any one of the following:
(1) in a case that the second terminal is currently in an idle state or an inactive state, the first message is used to request or indicate the second terminal to enter a connected state and feed back the information about the second terminal;
(2) in a case that the second terminal is currently in an idle state or an inactive state, the first message is used to request or indicate the second terminal to enter a connected state; and
(3) the first message is used to request or indicate feeding back the information about the second terminal.

For example, the second terminal in any state feeds back the information about the second terminal. For example, the second terminal feeds back corresponding information based on its statue. For example, in a connected state, a C-RNTI is fed back; in an inactive state, an inactive radio network temporary identifier I-RNTI) is fed back, and in an idle state, a fifth-generation mobile communication system temporary mobile subscription identifier (5G S-Temporary Mobile Subscription Identifier, 5G-STMSI) is fed back.

In an implementation of this application, the method further includes:
receiving, by the first terminal, a second message sent by the network-side device, where the second message is used to indicate the first terminal to report information about a target terminal; and
selecting, by the first terminal, the second terminal as the target terminal.

The target terminal satisfies at least one of the following:
(1) A serving cell of the target terminal is the same as a serving cell of the first terminal.

That is, the first terminal selects the second terminal from its serving cell.
(2) The serving cell of the target terminal is different from the serving cell of the first terminal.

For example, the first terminal selects the second terminal from other cells belonging to a same base station.
(3) The serving cell of the target terminal is a target cell, and the second message carries information about the target cell.
(4) A distance between the target terminal and the first terminal is less than or equal to a preset distance threshold.

For example, the first terminal can successfully discover the target terminal through a discovery procedure.
(5) A link between the target terminal and the first terminal meets a preset transmission requirement.

For example, the preset transmission requirement may include, but is not limited to, at least one of the following: quality of a PC5 link between the first terminal and the target terminal is greater than or equal to a preset first threshold, and interference on a link between the first terminal and the target terminal is less than a preset second threshold.
(6) An interworking condition between the target terminal and the first terminal meets a preset requirement.

For example, the preset requirement may include, but is not limited to, that the first terminal and the target terminal can establish a connection through short-range communication technologies such as Bluetooth and Wi-Fi.
(7) The target terminal meets a requirement for establishing multi-terminal aggregation.

For example, that the target terminal meets a requirement for establishing multi-terminal aggregation may include but is not limited to at least one of the following: uplink transmission resources of the target terminal are greater than or equal to a third threshold, and Uu link quality of the target terminal is greater than or equal to a preset fourth threshold.

In this embodiment of this application, the first terminal can send, to the network-side device, the information about the second terminal with which the first terminal wants to establish multi-terminal aggregation, and establish multi-path transmission for multi-terminal aggregation with the second terminal based on the configuration of the network-side device, so as to transmit different signaling and service data on multiple paths, thereby improving communication performance in terms of reliability, throughput, and the like.

Referring to FIG. 5, an embodiment of the application provides a

multi-terminal aggregation establishment method, applied to a second terminal. The second terminal includes but is not limited to a remote terminal and a primary terminal. The specific steps include step 501, step 502, and step 503.

Step 501: The second terminal sends information about the second terminal to a first terminal, where the information about the second terminal is used to assist a network-side device in configuring configuration information for establishing multi-terminal aggregation.

In an implementation of this application, the information about the second terminal includes at least one of the following:
(1) an identifier of the second terminal, such as C-RNTI;
(2) serving cell information of the second terminal, such as NCGI;
(3) PLMN information of the second terminal;
(4) link quality between the first terminal and the second terminal; and
(5) Uu link quality of the second terminal.

Step 502: The second terminal receives the configuration information sent by the network-side device.

Step 503: The second terminal establishes multi-path transmission for multi-terminal aggregation with the first terminal based on the configuration information.

That is, the second terminal can complete the process of multi-terminal aggregation establishment based on the configuration information.

In an implementation of this application, the method may further include:
receiving, by the second terminal, a first message sent by the first terminal; where the first message is used to request the second terminal to feed back the information about the second terminal.

The first message satisfies any one of the following:
(1) in a case that the second terminal is currently in an idle state or an inactive state, the first message is used to request or indicate the second terminal to enter a connected state and feed back the information about the second terminal;
(2) in a case that the second terminal is currently in an idle state or an inactive state, the first message is used to request or indicate the second terminal to enter a connected state; and
(3) the first message is used to request or indicate feeding back the information about the second terminal.

In an implementation of this application, the method further includes:
sending, by the second terminal, a third message to the network-side device, where the third message is used to indicate a cause for the second terminal entering a connected state from an idle or inactive state, for example, the cause may be establishing UE aggregation with the first terminal.

In this embodiment of this application, the first terminal can send, to the network-side device, the information about the second terminal with which the first terminal wants to establish multi-terminal aggregation, and establish multi-path transmission for multi-terminal aggregation with the second terminal based on the configuration of the network-side device, so as to transmit different signaling and service data on multiple paths, thereby improving communication performance in terms of reliability, throughput, and the like.

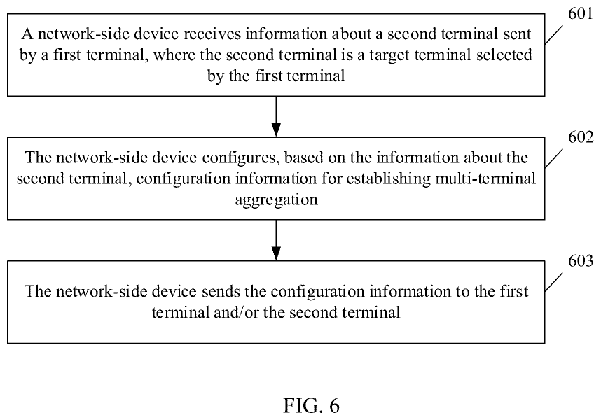

Referring to FIG. 6, an embodiment of this application provides a multi-terminal aggregation establishment configuration method, applied to a network-side device, and the specific steps include: step 601, step 602, and step 603.

Step 601: The network-side device receives information about a second terminal sent by a first terminal, where the second terminal is a target terminal selected by the first terminal.

In an implementation of this application, the information about the second terminal includes at least one of the following:
(1) an identifier of the second terminal, such as C-RNTI;
(2) serving cell information of the second terminal, such as NCGI;
(3) PLMN information of the second terminal;
(4) link quality between the first terminal and the second terminal; and
(5) Uu link quality of the second terminal.

Step 602: The network-side device configures, based on the information about the second terminal, configuration information for establishing multi-terminal aggregation.

Step 603: The network-side device sends the configuration information to the first terminal and/or the second terminal.

In an implementation of this application, the method further includes:
sending, by the network-side device, a second message to the first terminal, where the second message is used to indicate the first terminal to report information about a target terminal.

The target terminal satisfies at least one of the following:
(1) A serving cell of the target terminal is the same as a serving cell of the first terminal.
(2) The serving cell of the target terminal is different from the serving cell of the first terminal.
(3) The serving cell of the target terminal is a target cell, and the second message carries information about the target cell.
(4) A distance between the target terminal and the first terminal is less than or equal to a preset distance threshold.
(5) A link between the target terminal and the first terminal meets a preset

transmission requirement.
(6) An interworking condition between the target terminal and the first terminal meets a preset requirement.
(7) The target terminal meets a requirement for establishing multi-terminal aggregation.

In an implementation of this application, the method further includes:
receiving, by the network-side, a third message sent by the second terminal, where the third message is used to indicate a cause for the second terminal entering a connected state from an idle or inactive state, for example, the cause may be establishing UE aggregation with the first terminal.

In this embodiment of the application, when the network-side device determines that there is a requirement for the first terminal to establish multi-path transmission for multi-UE aggregation, the network-side device can indicate the first terminal to select a target terminal, and the network-side device may further configure, for the first terminal and the second terminal based on information about the second terminal reported by the first terminal, configuration information for establishing multi-terminal aggregation, so as to transmit different signaling and service data on the multi-path to improve communication performance in terms of reliability, throughput, and the like.

The following describes the implementations of this application by using example 1 and example 2. In the following embodiments, UE1 is equivalent to the first terminal, UE2 is equivalent to the second terminal, and the base station is equivalent to the network-side device.

Embodiment 1: UE1 reports information about UE2 to the network.

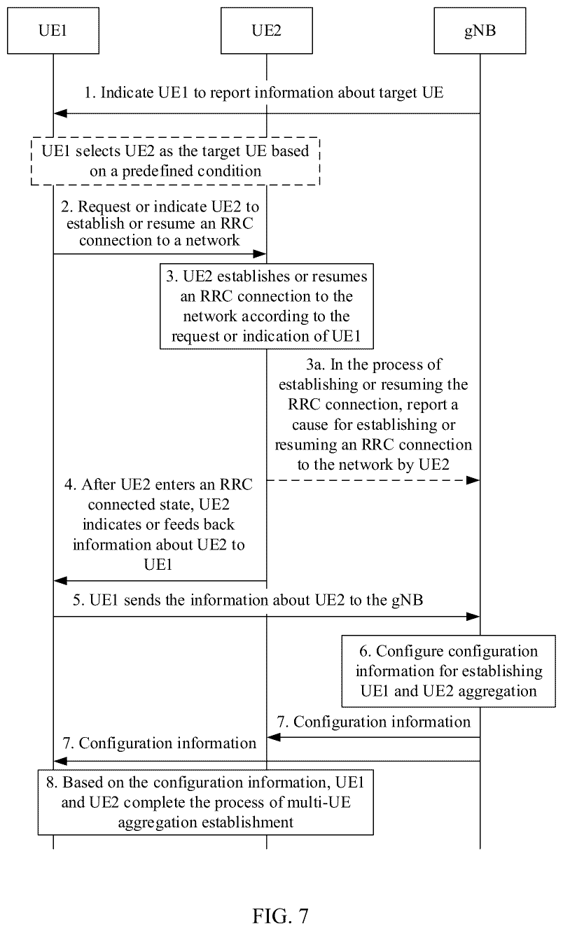

Referring to FIG. 7, specific steps include:
Step 1: The base station (for example, the next Generation Node B, gNB) indicates UE1 to report information about the target UE, such as information about UE2.

Optionally, the information about UE2 may include one or more of a UE ID (such as C-RNTI), a serving cell ID (such as NCGI), and a serving PLMN ID.

The target UE meets a preset condition, and the preset condition includes at least one of the following:
(1) The target UE is near UE1, that is, UE1 can successfully discover the target through the discovery procedure.
(2) A link between UE1 and the target UE meets a preset transmission requirement. For example, quality of a PC5 link between UE1 and the target UE is greater than or equal to a preset threshold.
(3) An interworking condition between UE1 and the target UE meet a preset requirement. For example, UE1 and the target UE can establish a connection between UE1 and the target UE, for example, through Wi-Fi, Bluetooth, or the like.
(4) The target UE meets a requirement for establishing multi-UE aggregation.

Step 2: UEl requests or indicates UE2 to establish or resume an RRC connection to the network.

For example, UEl determines that UE2 is in an idle state (RCC_idle) or an inactive state (RRC_inactive), and UE1 can request or indicate UE2 to establish or resume an RRC connection to the network.

Optionally, that UEl requests or indicates UE2 to establish or resume an RRC connection to the network may include any one of the following:
(1) UE1 requests UE2 to feed back a UE ID, for example, UEl requests or indicates UE2 to feed back a C-RNTI.
(2) UE1 “triggers UE2 to enter a connected state (RRC_CONNECTED)”, and after successfully entering RRC_CONNECTED, UE2 actively feeds back a C-RNTI of UE2, serving cell information, and so on.

Step 3: UE2 can establish or resume an RRC connection to the network according to the request or indication of UE1.

Optionally, step 3a: In the process of establishing or resuming the RRC connection, UE2 may report to the gNB a cause for establishing or resuming an RRC connection to the network by UE2, for example, the cause may be establishing multi-UE aggregation with UE1.

Step 4: After UE2 enters the RRC connected state, UE2 indicates or feeds back the information about UE2 to UE1.

Optionally, the information about UE2 includes at least one of the C-RNTI of UE2, serving cell information of UE2 (such as an NCGI), serving PLMN information of UE2 (such as a PLMN ID), and link quality between UE1 and UE2.

Step 5: After UEl receives the information about UE2, UEl reports the information about UE2 to the gNB.

Step 6: When the gNB receives the information about UE2 reported by UE1, the gNB can determine to configure, for UE1 and UE2, configuration information for establishing UE1 and UE2 aggregation.

Step 7 and Step 8: The gNB sends the configuration information to UE1 and UE2, and UE1 and UE2 complete the process of multi-UE aggregation establishment.

Embodiment 2: UE1 reports information about the target UE in a designated area to the network.

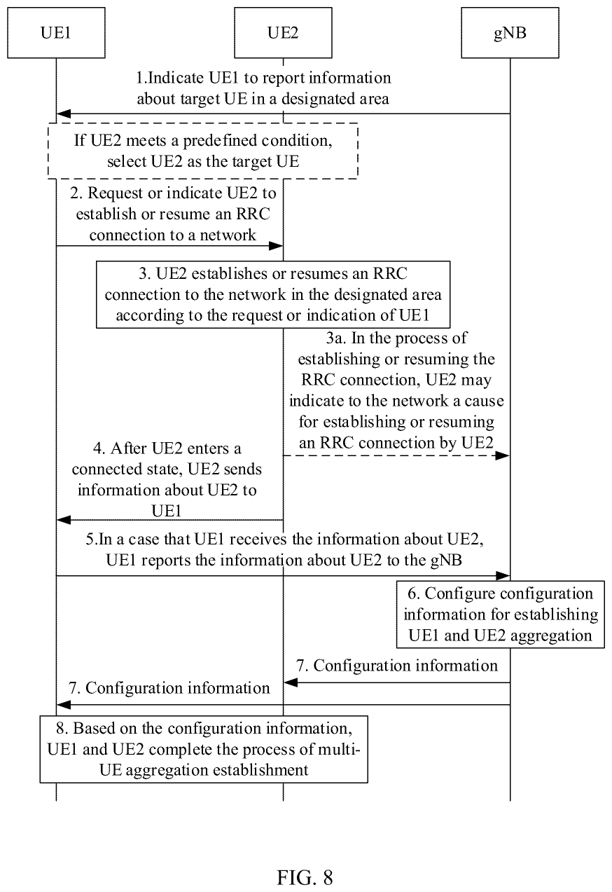

Referring to FIG. 8, specific steps include:

Step 1: The gNB indicates UEl to report the information about the target UE in the designated area (for example, cell 1 (Cell 1)).

For example, the gNB indicates UE1 to report the information about the target UE in the serving cell (for example, Cell 1).

If UE1 finds that a serving cell of UE2 is also Cell 1, and UE2 meets a preset condition, the preset condition includes at least one of the following:
(1) A link between UEl and the target UE meets a preset transmission requirement. For example, quality of a PC5 link between UE and the target UE is greater than or equal to a preset threshold.
(2) An interworking condition between UEl and the target UE meet a preset requirement. For example, UE1 and the target UE can establish a connection between UE1 and the target UE, for example, through Wi-Fi, Bluetooth, or the like.
(3) The target UE meets a requirement for establishing multi-UE aggregation.

Step 2: UE1 determines that UE2 is in an idle state or an inactive state, and UE1 can request or indicate UE2 to establish or resume an RRC connection to the network.

Optionally, that UEl requests or indicates UE2 to establish or resume an RRC connection to the network may include any one of the following:
(1) UE1 requests UE2 to feed back a UE ID, for example, UEl requests or indicates UE2 to feed back a C-RNTI.
(2) UE1 “triggers UE2 to enter RRC_CONNECTED”, and after successfully entering RRC_CONNECTED, UE2 actively feeds back a C-RNTI of UE2, a serving cell identifier, and so on.

Further, UE1 “triggers UE2 to enter RRC_CONNECTED based on the specified Cell 1”, and UE2 actively feeds back a C-RNTI of UE2 after successfully entering RRC_CONNECTED.

Step 3: UE2 can establish or resume an RRC connection to the network in the designated area according to the request or indication of UE1.

Optionally, in the process of establishing or resuming the RRC connection, UE2 may indicate to the network a cause for establishing or resuming an RRC connection by UE2, for example, to establish UE aggregation with UE1.

Step 4: After UE2 enters the connected state, UE2 sends the information about UE2 to UE1.

Step 5: In a case that UEl receives the information about UE2, UEl reports the information about UE2 to the gNB.

Optionally, the information about UE2 includes at least one of the C-RNTI of UE2, serving cell information of UE2 (such as an NCGI), serving PLMN information of UE2 (such as a PLMN ID), link quality between UE1 and UE2, and the like.
Step 6: When the gNB receives the information about UE2 reported by UE1, the gNB determines to configure, for UE1 and UE2, configuration information for establishing UE1 and UE2 aggregation.
Step 7 and Step 8: The gNB sends the configuration information to UE1 and UE2, and UE1 and UE2 complete the process of multi-UE aggregation establishment.

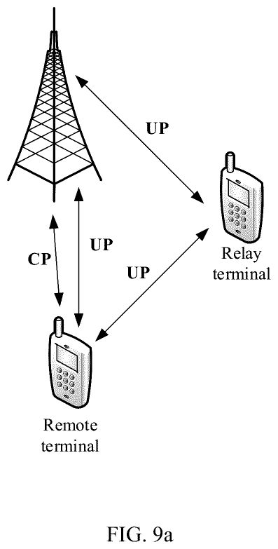

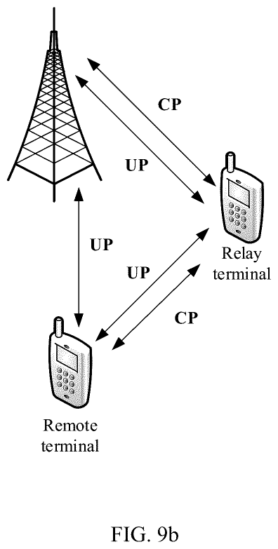

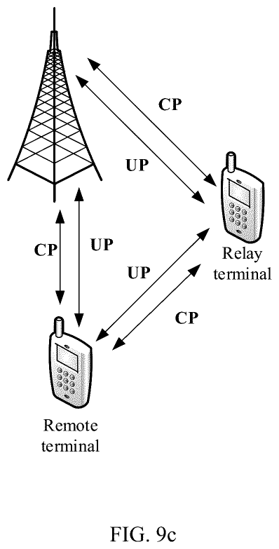

For an SL relay architecture, multiple path means that the remote UE establishes both an indirect path and a direct path, as shown in FIG. 9a, FIG. 9b, and FIG. 9c.

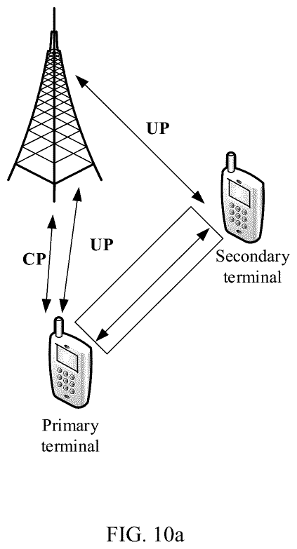

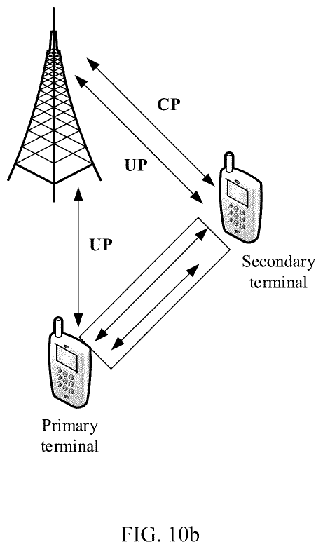

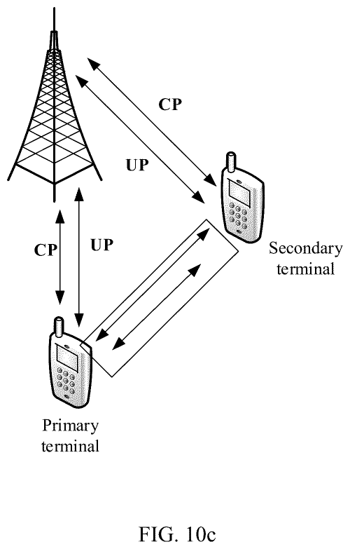

For a non-SL relay architecture, a connection between two UEs is not a sidelink (PC5) interface, assuming that the interface between them is a wired connection or an ideal inter-UE connection (ideal inter-UE connection). Here, multi-path means that primary UE establishes both an indirect path and a direct path, as shown in FIGS. 10a, 10b, and 10c.

The indirect path refers to a radio link through which a remote UE (or a primary UE) establishes an RRC connection to a base station through a relay UE (or a secondary UE) and a Uu interface of a relay UE (or a Secondary UE).

The direct path refers to a radio link through which a remote UE (or a primary UE) establishes an RRC connection to a base station through its own Uu air interface.

This embodiment of this application can be applied to establishment of multi-terminal aggregation between the remote UE and the relay UE in the multi-path scenarios shown in FIGS. 9a to 9c, and can be also applied to establishment of multi-terminal aggregation between the primary UE and the secondary UE in the multi-path scenarios shown in FIGS. 10a to 10c.

It should be noted that this application is not limited to the SL relay architecture; as long as multi-path transmission for multi-terminal aggregation can be achieved, it falls within the scope of this application.

In addition, the multi-UE aggregation mentioned in the embodiments of this application includes that one service flow is transmitted through multiple sessions corresponding to multiple UEs. For example, first UE may transfer all or part of its own service flow data to second UE for uplink transmission to the wireless communication network; and the first UE can receive service flow data from the second UE, and aggregate and reorder it along with its own service flow data received from the network side to form a complete service flow. The interaction between the first UE and the second UE may be based on wired connection, Wi-Fi, Bluetooth, a PC5 interface, or the like.

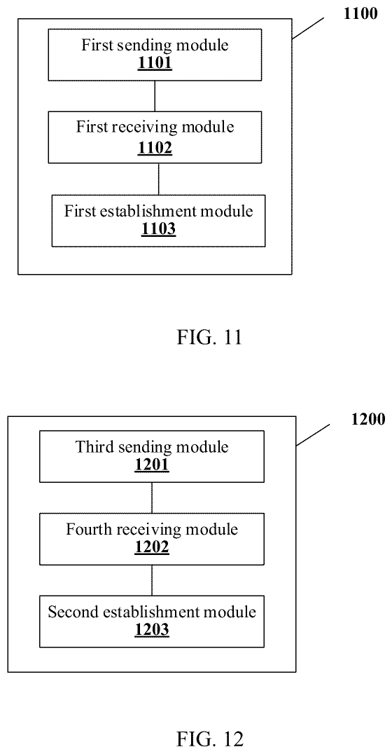

Referring to FIG. 11, an embodiment of this application provides a multi-terminal aggregation establishment apparatus, applied to a first terminal, and the apparatus 1100 includes:
a first sending module 1101, configured to send information about a second terminal to a network-side device, where the information about the second terminal is used to assist the network-side device in configuring configuration information for establishing multi-terminal aggregation;
a first receiving module 1102, configured to receive the configuration information sent by the network-side device; and a1 first establishment module 1103, configured to establish multi-path transmission for multi-terminal aggregation with the second terminal based on the configuration information.

In an implementation of this application, the apparatus further includes:
a second sending module, configured to send a first message to the second terminal, where the first message is used to request the second terminal to feed back the information about the second terminal; and
a second receiving module, configured to receive the information about the second terminal; where
the first message satisfies any one of the following:
(1) in a case that the second terminal is currently in an idle state or an inactive state, the first message is used to request or indicate the second terminal to enter a connected state and feed back the information about the second terminal;
(2) in a case that the second terminal is currently in an idle state or an inactive state, the first message is used to request or indicate the second terminal to enter a connected state; and
(3) the first message is used to request or indicate feeding back the information about the second terminal.

In an implementation of this application, the apparatus further includes:
a third receiving module, configured to receive a second message sent by the network-side device, where the second message is used to indicate the first terminal to report information about a target terminal; and
a selection module, configured to select the second terminal as the target terminal; where
the target terminal satisfies at least one of the following:
   (1) a serving cell of the target terminal is the same as a serving cell of the first terminal;
   (2) the serving cell of the target terminal is different from the serving cell of the first terminal;
   (3) the serving cell of the target terminal is a target cell, and the second message carries information about the target cell;
   (4) a distance between the target terminal and the first terminal is less than or equal to a preset distance threshold;
   (5) a link between the target terminal and the first terminal meets a preset transmission requirement;
   (6) an interworking condition between the target terminal and the first terminal meets a preset requirement; and
   (7) the target terminal meets a requirement for establishing multi-terminal aggregation.

In an implementation of this application, the information about the second terminal includes at least one of an identifier of the second terminal, information about a serving cell of the second terminal, public land mobile network PLMN information of the second terminal, link quality between the first terminal and the second terminal, and Uu link quality of the second terminal.

The apparatus provided in this embodiment of this application can implement the processes implemented in the method embodiment in FIG. 4, with the same technical effects achieved. To avoid repetition, details are not described herein again.

Referring to FIG. 12, an embodiment of this application provides a multi-terminal aggregation establishment apparatus, applied to a second terminal, and the apparatus 1200 includes:
a third sending module 1201, configured to send information about a second terminal to a first terminal, where the information about the second terminal is used to assist a network-side device in configuring configuration information for establishing multi-terminal aggregation;
a fourth receiving module 1202, configured to receive the configuration information sent by the network-side device; and
a second establishment module 1203, configured to establish multi-path transmission for multi-terminal aggregation with the first terminal based on the configuration information.

In an implementation of this application, the apparatus further includes:
a fifth receiving module, configured to receive a first message sent by the first terminal, where the first message is used to request the second terminal to feed back the information about the second terminal; where
the first message satisfies any one of the following:
   (1) in a case that the second terminal is currently in an idle state or an inactive state, the first message is used to request or indicate the second terminal to enter a connected state and feed back the information about the second terminal;
   (2) in a case that the second terminal is currently in an idle state or an inactive state, the first message is used to request or indicate the second terminal to enter a connected state; and
   (3) the first message is used to request or indicate feeding back the information about the second terminal.

In an implementation of this application, the apparatus further includes:
a fourth sending module, configured to send a third message to the network-side device, where the third message is used to indicate a cause for the second terminal entering a connected state from an idle or inactive state.

In an implementation of this application, the information about the second terminal includes at least one of an identifier of the second terminal, information about a serving cell of the second terminal, PLMN information of the second terminal, link quality between the first terminal and the second terminal, and Uu link quality of the second terminal.

The apparatus provided in this embodiment of this application can implement the processes implemented in the method embodiment in FIG. 5, with the same technical effects achieved. To avoid repetition, details are not described herein again.

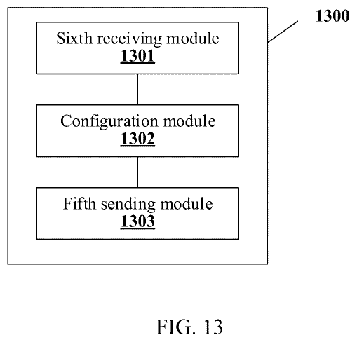

Referring to FIG. 13, an embodiment of this application provides a multi-terminal aggregation establishment configuration apparatus, applied to a network-side device, and the apparatus 1300 includes:
a sixth receiving module 1301, configured to receive information about a second terminal sent by a first terminal; where the second terminal is a target terminal selected by the first terminal;
a configuration module 1302, configured to, based on the information about the second terminal, configure configuration information for establishing multi-terminal aggregation; and
a fifth sending module 1303, configured to send the configuration information to the first terminal and/or the second terminal.

In an implementation of this application, the apparatus further includes:
a sixth sending module, configured to send a second message to the first terminal, where the second message is used to indicate the first terminal to report information about a target terminal; where
the target terminal satisfies at least one of the following:
   (1) a serving cell of the target terminal is the same as a serving cell of the first terminal;
   (2) the serving cell of the target terminal is different from the serving cell of the first terminal;
   (3) the serving cell of the target terminal is a target cell, and the second message carries information about the target cell;
   (4) a distance between the target terminal and the first terminal is less than or equal to a preset distance threshold;
   (5) a link between the target terminal and the first terminal meets a preset transmission requirement;
   (6) an interworking condition between the target terminal and the first terminal meets a preset requirement; and
   (7) the target terminal meets a requirement for establishing multi-terminal aggregation.

In an implementation of this application, the apparatus further includes:
a seventh receiving module, configured to receive a third message sent by the second terminal, where the third message is used to indicate a cause for the second terminal entering a connected state from an idle or inactive state.

In an implementation of this application, the information about the second terminal includes at least one of an identifier of the second terminal, information about a serving cell of the second terminal, PLMN information of the second terminal, link quality between the first terminal and the second terminal, and Uu link quality of the second terminal.

The apparatus provided in this embodiment of this application can implement the processes implemented in the method embodiment in FIG. 6, with the same technical effects achieved. To avoid repetition, details are not described herein again.

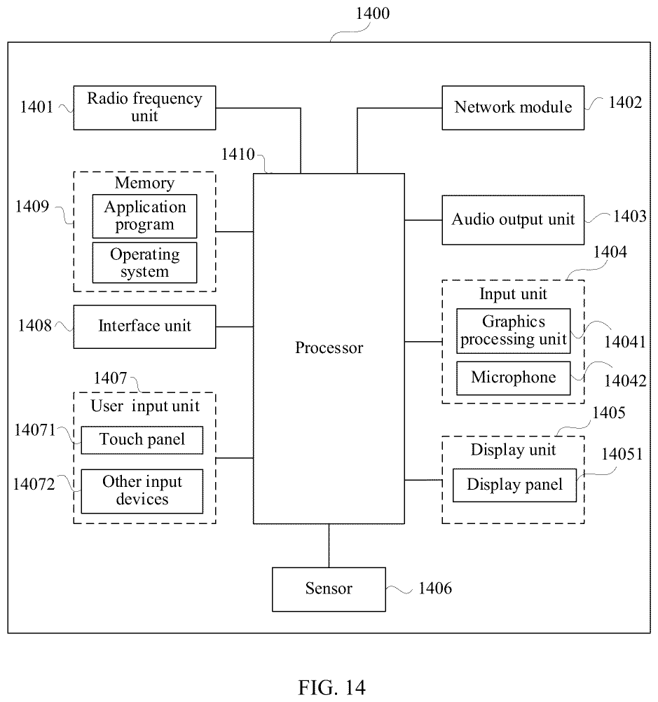

FIG. 14 is a schematic diagram of a hardware structure of a terminal for implementing the embodiments of this application. The terminal 1400 includes but is not limited to at least part of components such as a radio frequency unit 1401, a network module 1402, an audio output unit 1403, an input unit 1404, a sensor 1406, a display unit 1405, a user input unit 1407, an interface unit 1408, a memory 1409, and a processor 1410.

Persons skilled in the art can understand that the terminal 1400 may further include a power supply (for example, a battery) supplying power to the components, and the power supply may be logically connected to the processor 1410 through a power management system. In this way, functions such as charge management, discharge management, and power consumption management are implemented by using the power management system. The structure of the terminal shown in FIG. 14 does not constitute any limitation on the terminal. The terminal may include more or fewer components than shown in the figure, or a combination of some components, or the components disposed differently. Details are not described herein again.

It can be understood that in this embodiment of this application, the input unit 1404 may include a graphics processing unit (GPU) 14041 and a microphone 14042. The graphics processing unit 14041 processes image data of a still picture or video obtained by an image capture apparatus (such as a camera) in a video capture mode or an image capture mode. The display unit 1406 may include a display panel 14051, and the display panel 14051 may be configured in a form of a liquid crystal display, an organic light-emitting diode, and the like. The user input unit 1407 includes at least one of a touch panel 14071 and other input devices 14072. The touch panel 14071 is also referred to as a touchscreen. The touch panel 14071 may include two parts: a touch detection apparatus and a touch controller. The other input devices 14072 may include but are not limited to a physical keyboard, a function key (such as a volume control key or a power on/off key), a trackball, a mouse, a joystick, and the like. Details are not described herein.

In this embodiment of this application, after receiving downlink data from a network-side device, the radio frequency unit 1401 sends the downlink data to the processor 1410 for processing; and the radio frequency unit 1401 also sends uplink data to the network-side device. Generally, the radio frequency unit 1401 includes, but is not limited to, an antenna, an amplifier, a transceiver, a coupler, a low noise amplifier, a duplexer, and the like.

The memory 1409 may be configured to store software programs or instructions and various data. The memory 1409 may mainly include a first storage area for storing programs or instructions and a second storage area for storing data, where the first storage area may store an operating system, an application program or instructions required by at least one function (for example, an audio playing function and an image playing function), and the like. In addition, the memory 1409 may be a volatile memory or a non-volatile memory, or the memory 1409 may include a volatile memory and a non-volatile memory. The non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), a static random access memory (Static RAM, SRAM), a dynamic random access memory (Dynamic RAM, DRAM), synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchronous link dynamic random access memory (Synch link DRAM, SLDRAM), and a direct memory bus random access memory (Direct Rambus RAM, DRRAM). The memory 1409 described in this embodiment this application includes but is not limited to these and any other suitable types of memories.

The processor 1410 may include one or more processing units. Optionally, the processor 1410 integrates an application processor and a modem processor. The application processor mainly processes operations related to an operating system, a user interface, an application program, and the like. The modem processor mainly processes wireless communication signals, for example, a baseband processor. It can be understood that the modem processor may alternatively be not integrated in the processor 1410.

The terminal provided by the embodiments of this application is capable of implementing the processes implemented in the method embodiments in FIG. 4 or FIG. 5, with the same technical effects achieved. To avoid repetition, details are not described herein again.

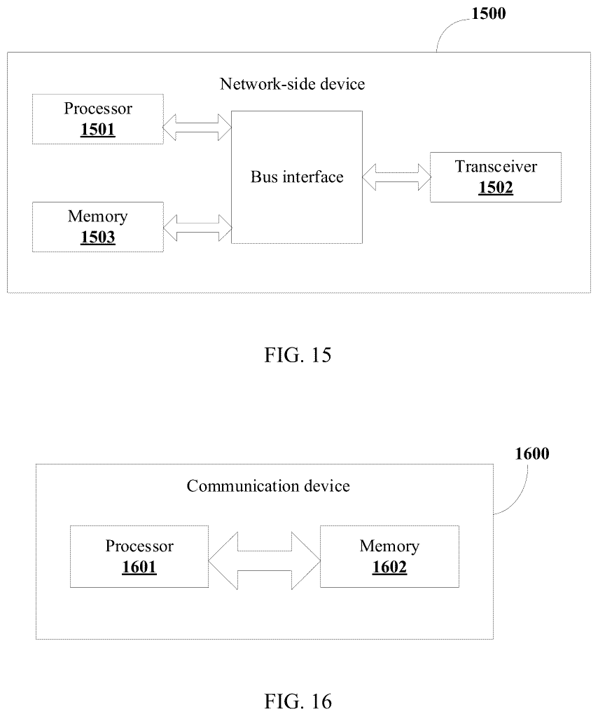

Referring to FIG. 15, FIG. 15 is a structural diagram of a network-side device to which the embodiments of this application is applied. As shown in FIG. 15, the communication device 1500 includes a processor 1501, a transceiver 1502, a memory 1503, and a bus interface. The processor 1501 may be responsible for managing a bus architecture and general processing. The memory 1503 may store data that the processor 1501 uses when performing an operation.

In an embodiment of this application, the communication device 1500 further includes a program stored in the memory 1503 and capable of running on the processor 1501. When the program is executed by the processor 1501, the steps of the foregoing method shown in FIG. 8 are implemented.

In FIG. 15, a bus architecture may include any quantity of interconnected buses and bridges, specifically for interconnecting various circuits of one or more processors represented by the processor 1501 and a memory represented by the memory 1503. The bus architecture may further interconnect various other circuits such as a peripheral device, a voltage regulator, and a power management circuit. These are all well known in the art, and therefore are not further described in this specification. The bus interface provides an interface. The transceiver 1502 may be a plurality of components, including a transmitter and a receiver, and provides units for communicating with a variety of other apparatuses on a transmission medium.

As shown in FIG. 16, an embodiment of this application further provides a communication device 1600, including a processor 1601 and a memory 1602. The memory 1602 stores a program or instructions capable of running on the processor 1601. For example, when the communication device 1600 is a terminal, the program or instructions are executed by the processor 1601 to implement the steps of the corresponding method embodiments of FIG. 6 or FIG. 7; and when the communication device 1600 is a network-side device, the program or instructions are executed by the processor 1601 to implement the steps of the corresponding method embodiments of FIG. 6, with the same technical effects achieved. To avoid repetition, details are not described herein again.

An embodiment of this application further provides a readable storage medium, where a program or instructions are stored in the readable storage medium. When the program or the instructions are executed by a processor, the processes shown in FIG. 4, FIG. 5, or FIG. 6 and the foregoing method embodiments are implemented, with same technical effects achieved. To avoid repetition, details are not described herein again.

The processor is a processor in the terminal described in the above embodiments. The readable storage medium includes a computer-readable storage medium, for example, a computer read only memory ROM, a random access memory RAM, a magnetic disk, or an optical disc.

An embodiment of this application further provides a chip. The chip includes a processor and a communication interface. The communication interface is coupled to the processor. The processor is configured to run a program or instructions to implement the processes shown in FIG. 4, FIG. 5, or FIG. 6 and the foregoing method embodiments, with the same technical effects achieved. To avoid repetition, details are not described herein again.

It should be understood that the chip mentioned in the embodiments of this application may also be referred to as a system-level chip, a system chip, a chip system, a system-on-chip, or the like.

An embodiment of this application further provides a computer program/program product, where the computer program/program product is stored in a storage medium, and when being executed by at least one processor, the computer program/program product is configured to implement the processes shown in FIG. 4, FIG. 5, or FIG. 6 and the foregoing method embodiments, with the same technical effects achieved. To avoid repetition, details are not repeated herein.

An embodiment of this application further provides a communication system, where the communication system includes a terminal and a network-side device. The terminal is configured to execute the processes shown in FIG. 4 or FIG. 5 and the foregoing method embodiments, and the network-side device is configured to execute the processes shown in FIG. 6 and the foregoing method embodiments, with the same technical effects achieved. To avoid repetition, details are not repeated herein.

It should be noted that in this specification, the terms “include” and “comprise”, or any of their variants are intended to cover a non-exclusive inclusion, such that a process, method, article, or apparatus that includes a list of elements not only includes those elements but also includes other elements that are not expressly listed, or further includes elements inherent to such process, method, article, or apparatus. In absence of more constraints, an element preceded by “includes a . . . ” does not preclude the existence of other identical elements in the process, method, article, or apparatus that includes the element. Furthermore, it should be noted that the scope of the methods and apparatuses in the embodiments of this application is not limited to performing the functions in the order shown or discussed, but may also include performing the functions in a substantially simultaneous manner or in a reverse order depending on the functions involved. For example, the described methods may be performed in an order different from that described, and various steps may be added, omitted, or combined. In addition, features described with reference to some examples may be combined in other examples.

According to the description of the foregoing implementations, persons skilled in the art can clearly understand that the method in the foregoing embodiments may be implemented by software in combination with a necessary general hardware platform. Specifically, the method in the foregoing embodiments may alternatively be implemented by hardware. However, in many cases, the former is a preferred implementation. Based on such an understanding, the technical solutions of this application essentially or the part contributing to the prior art may be implemented in a form of a computer software product. The computer software product is stored in a storage medium (such as a ROM/RAM, a magnetic disk, or an optical disc), and includes several instructions for instructing a terminal (which may be a mobile phone, a computer, a server, an air conditioner, a network device, or the like) to perform the methods described in the embodiments of this application.

The foregoing describes the embodiments of this application with reference to the accompanying drawings. However, this application is not limited to the foregoing specific implementations. These specific implementations are merely illustrative rather than restrictive. Inspired by this application, persons of ordinary skill in the art may develop many other forms without departing from the essence of this application and the protection scope of the claims, and all such forms shall fall within the protection scope of this application.

What is claimed is:

1. A multi-terminal aggregation establishment method, comprising:
sending, by a first terminal, information about a second terminal to a network-side device, wherein the information about the second terminal is used to assist the network-side device in configuring configuration information for establishing multi-terminal aggregation;
receiving, by the first terminal, the configuration information sent by the network-side device; and
establishing, by the first terminal, multi-path transmission for multi-terminal aggregation with the second terminal based on the configuration information.

2. The method according to claim 1, wherein the method further comprises:
sending, by the first terminal, a first message to the second terminal; and
receiving, by the first terminal, information about the second terminal; wherein the first message satisfies any one of the following:
in a case that the second terminal is currently in an idle state or an inactive state, the first message is used to request or indicate the second terminal to enter a connected state and feed back the information about the second terminal;
in a case that the second terminal is currently in an idle state or an inactive state, the first message is used to request or indicate the second terminal to enter a connected state; and
the first message is used to request or indicate feeding back the information about the second terminal.

3. The method according to claim 1, wherein the method further comprises:
receiving, by the first terminal, a second message sent by the network-side device, wherein the second message is used to indicate the first terminal to report information about a target terminal; and
selecting, by the first terminal, the second terminal as the target terminal; wherein
the target terminal satisfies at least one of the following:
a serving cell of the target terminal is the same as a serving cell of the first terminal;
the serving cell of the target terminal is different from the serving cell of the first terminal;
the serving cell of the target terminal is a target cell, and the second message carries information about the target cell;
a distance between the target terminal and the first terminal is less than or equal to a preset distance threshold;
a link between the target terminal and the first terminal meets a preset transmission requirement;
an interworking condition between the target terminal and the first terminal meets a preset requirement; or
the target terminal meets a requirement for establishing multi-terminal aggregation.

4. The method according to claim 1, wherein the information about the second terminal comprises at least one of an identifier of the second terminal, information about a serving cell of the second terminal, public land mobile network PLMN information of the second terminal, link quality between the first terminal and the second terminal, or Uu link quality of the second terminal.

5. A multi-terminal aggregation establishment method, comprising:
sending, by a second terminal, information about the second terminal to a first terminal, wherein the information about the second terminal is used to assist a network-side device in configuring configuration information for establishing multi-terminal aggregation;
receiving, by the second terminal, the configuration information sent by the network-side device; and
establishing, by the second terminal, multi-path transmission for multi-terminal aggregation with the first terminal based on the configuration information.

6. The method according to claim 5, wherein the method further comprises:
receiving, by the second terminal, a first message sent by the first terminal;
wherein
the first message satisfies any one of the following:
in a case that the second terminal is currently in an idle state or an inactive state, the first message is used to request or indicate the second terminal to enter a connected state and feed back the information about the second terminal;
in a case that the second terminal is currently in an idle state or an inactive state, the first message is used to request or indicate the second terminal to enter a connected state; and
the first message is used to request or indicate feeding back the information about the second terminal.

7. The method according to claim 5, wherein the method further comprises:
sending, by the second terminal, a third message to the network-side device, wherein the third message is used to indicate a cause for the second terminal entering a connected state from an idle or inactive state.

8. The method according to claim 5, wherein the information about the second terminal comprises at least one of an identifier of the second terminal, information about a serving cell of the second terminal, PLMN information of the second terminal, link quality between the first terminal and the second terminal, or Uu link quality of the second terminal.

9. A multi-terminal aggregation establishment configuration method, comprising:
receiving, by a network-side device, information about a second terminal sent by a first terminal;
configuring, by the network-side device based on the information about the second terminal, configuration information for establishing multi-terminal aggregation; and
sending, by the network-side device, the configuration information to the first terminal and/or the second terminal.

10. The method according to claim 9, wherein the method further comprises:
sending, by the network-side device, a second message to the first terminal, wherein the second message is used to indicate the first terminal to report information about a target terminal; wherein the target terminal satisfies at least one of the following:
a serving cell of the target terminal is the same as a serving cell of the first terminal;
the serving cell of the target terminal is different from the serving cell of the first terminal;
the serving cell of the target terminal is a target cell, and the second message carries information about the target cell;
a distance between the target terminal and the first terminal is less than or equal to a preset distance threshold;
a link between the target terminal and the first terminal meets a preset transmission requirement;
an interworking condition between the target terminal and the first terminal meets a preset requirement; or the target terminal meets a requirement for establishing multi-terminal aggregation.

11. The method according to claim 9, wherein the method further comprises:
receiving, by the network-side, a third message sent by the second terminal, wherein the third message is used to indicate a cause for the second terminal entering a connected state from an idle or inactive state.

12. The method according to claim 9, wherein the information about the second terminal comprises at least one of an identifier of the second terminal, information about a serving cell of the second terminal, PLMN information of the second terminal, link quality between the first terminal and the second terminal, or Uu link quality of the second terminal.

13. A first terminal, comprising a processor and a memory, wherein a program or instructions capable of running on the processor are stored in the memory, and the program or instructions, when executed by the processor, cause the first terminal to implement the steps of the method according to claim 1.

14. The first terminal according to claim 13, wherein the program or instructions, when executed by the processor, further cause the first terminal to implement:
sending a first message to the second terminal; and
receiving information about the second terminal; wherein the first message satisfies any one of the following:
in a case that the second terminal is currently in an idle state or an inactive state, the first message is used to request or indicate the second terminal to enter a connected state and feed back the information about the second terminal;
in a case that the second terminal is currently in an idle state or an inactive state, the first message is used to request or indicate the second terminal to enter a connected state; and
the first message is used to request or indicate feeding back the information about the second terminal.

15. The first terminal according to claim 13, wherein the program or instructions, when executed by the processor, further cause the first terminal to implement:
receiving a second message sent by the network-side device, wherein the second message is used to indicate the first terminal to report information about a target terminal; and
selecting the second terminal as the target terminal; wherein the target terminal satisfies at least one of the following:
a serving cell of the target terminal is the same as a serving cell of the first terminal;
the serving cell of the target terminal is different from the serving cell of the first terminal;
the serving cell of the target terminal is a target cell, and the second message carries information about the target cell;
a distance between the target terminal and the first terminal is less than or equal to a preset distance threshold;
a link between the target terminal and the first terminal meets a preset transmission requirement;
an interworking condition between the target terminal and the first terminal meets a preset requirement; or the target terminal meets a requirement for establishing multi-terminal aggregation.

16. The first terminal according to claim 13, wherein the information about the second terminal comprises at least one of an identifier of the second terminal, information about a serving cell of the second terminal, public land mobile network PLMN information of the second terminal, link quality between the first terminal and the second terminal, or Uu link quality of the second terminal.

17. A second terminal, comprising a processor and a memory, wherein a program or instructions capable of running on the processor are stored in the memory, and the program or instructions, when executed by the processor, cause the second terminal to implement the steps of the method according to claim 5.

18. The second terminal according to claim 17, wherein the program or instructions, when executed by the processor, further cause the second terminal to implement:
receiving a first message sent by the first terminal; wherein the first message satisfies any one of the following:
in a case that the second terminal is currently in an idle state or an inactive state, the first message is used to request or indicate the second terminal to enter a connected state and feed back the information about the second terminal;
in a case that the second terminal is currently in an idle state or an inactive state, the first message is used to request or indicate the second terminal to enter a connected state; and
the first message is used to request or indicate feeding back the information about the second terminal.

19. A network-side device, comprising a processor and a memory, wherein a program or instructions capable of running on the processor are stored in the memory, and the program or instructions, when executed by the processor, cause the first terminal to implement the steps of the method according to claim 9.

20. A non-transitory readable storage medium, wherein a program or instructions are stored on the non-transitory readable storage medium, and when the program or the instructions are executed by a processor, the steps of the method according to claim 1 are implemented.
